(19) United States
(12) Patent Application Publication
(10) Pub. No.: US 2025/0296335 A1
(43) Pub. Date: Sep. 25, 2025

(54) LIQUID EJECTION HEAD AND METHOD FOR MANUFACTURING LIQUID EJECTION HEAD

(71) Applicant: RISO Technologies Corporation, Tokyo (JP)

(72) Inventors: Takashi TOZUKA, Mishima Shizuoka (JP); Satoshi HIMENO, Mishima Shizuoka (JP); Tsubasa KONISHI, Mishima Shizuoka (JP)

(21) Appl. No.: 19/019,180

(22) Filed: Jan. 13, 2025

(30) Foreign Application Priority Data
Mar. 21, 2024 (JP) 2024-045403

(51) Int. Cl. B41J 2/14; B41J 2/045

(52) U.S. Cl. CPC B41J 2/14451; B41J 2/0453; B41J 2/04581; B41J 2/04588; B41J 2/14209; B41J 2002/14491

(57) ABSTRACT

A liquid ejection head includes nozzles through which liquid is ejected, pressure chambers communicating with the nozzles, volumes of the chambers being varied to eject the liquid, a substrate including an electrode on a surface of the substrate, an actuator connected to the electrode and configured to vary the volumes, the actuator having a first side surface connected to the surface of the substrate, a first cover member that covers the first side surface and includes openings each facing one of the chambers, the openings having larger fluid resistance than the chambers, an insulating material between the surface of the substrate and the first cover member, and an insulating film that covers the electrode on the substrate.

### CROSS-REFERENCE TO RELATED APPLICATION

This application is based upon and claims the benefit of priority from Japanese Patent Application No. 2024-045403, filed on Mar. 21, 2024, the entire contents of which are incorporated herein by reference.

### FIELD

Embodiments described herein relate generally to a liquid ejection head and a method for manufacturing the liquid ejection head.

### BACKGROUND

For a liquid ejection head such as an ink jet head, high productivity is required, and it is essential to increase a speed and an amount of liquid droplets. For example, an ink jet head of a shear mode shared wall type uses a shear mode that allows for a large displacement, and a pressure chamber formed by a piezoelectric body has high rigidity and high power, which makes the ink jet head suitable for ejecting ink with high viscosity and ejecting large droplets. On the other hand, since one drive column is shared by two pressure chambers, only ⅓ of the pressure chambers can be driven at the same time, which is a basis of a so-called three-cycle drive. To increase a speed, an independent drive head was developed in which a dummy pressure chamber is formed on both sides of a drive pressure chamber and one pressure chamber is driven by two independent drive columns. For example, a large number of grooves are formed in a piezoelectric body, and an inlet and an outlet of every other groove are closed by a photosensitive resin. In addition, the closed groove is used as an air chamber, and the groove whose inlet and outlet are not closed and that communicates with a common chamber is used as a pressure chamber.

In such an ink jet head, after an ink droplet is ejected, ink is replenished from a common liquid chamber, but a phenomenon occurs in which the ink overshoots in a nozzle and a meniscus swells. The smaller fluid resistance between the common liquid chamber and the nozzle, the larger the overshoot, and unless the overshoot is controlled, consistent ejection of droplets cannot be achieved. It is also important to quickly subside the swelling of the meniscus in order to increase the ejection speed. The larger the ink droplet, the more noticeable the swelling of the meniscus. Therefore, it is effective to increase the fluid resistance at an inlet of the pressure chamber. Although it is effective to reduce a cross section of the pressure chamber in a direction in which the ink is replenished as a method for increasing the fluid resistance, it is difficult to ensure throttle accuracy in a case where the resistance is generated by a photosensitive resin at an inlet and an outlet of a pressure chamber in the ink jet head of a shear mode shared wall type. On the other hand, a ceramic plate-shaped cover member may be joined to the inlet and the outlet of the pressure chamber as a method for generating flow path resistance.

When the cover member is joined, a gap may be formed between the cover member and a substrate. In this case, when an insulating film made of an adhesive is sprayed onto an electrode formation surface of the substrate by spraying or the like, the cover member acts as eaves, and it is difficult to insulate and protect electrode wiring immediately below the cover member.

### BRIEF DESCRIPTION OF THE DRAWINGS

FIG. 1 is a perspective view illustrating an ink jet head according to an embodiment.

FIG. 2 is a plan view illustrating a configuration of the ink jet head.

FIG. 3 is a plan view illustrating a configuration of a part of an actuator base.

FIG. 4 is a bottom view illustrating a configuration of the actuator base.

FIG. 5 is a cross-sectional view illustrating a configuration of a part of the ink jet head.

FIG. 6 is a perspective view illustrating a configuration of the actuator base.

FIG. 7 is a cross-sectional view illustrating a configuration of the actuator base.

FIG. 8 is a view illustrating a manufacturing method.

FIG. 9 is a view illustrating a configuration of the actuator base.

FIG. 10 is a view illustrating ink jet heads according to Test Example 1 and Test Example 2.

FIG. 11 is a graph illustrating an ejection speed of the ink jet head according to Test Example 1.

FIG. 12 is a graph illustrating an ejection speed of the ink jet head according to Test Example 2.

FIG. 13 is a graph illustrating meniscus recovery characteristics.

FIG. 14 is a schematic view illustrating an ink jet printer.

FIG. 15 is a cross-sectional view illustrating a configuration of an actuator base of an ink jet head according to a second embodiment.

FIG. 16 is a view illustrating a configuration of a substrate and an actuator.

### DETAILED DESCRIPTION

Embodiments of this disclosure provide a liquid ejection head that facilitates insulation protection of electrode wiring, and a method for manufacturing the liquid ejection head.

In general, according to one embodiment, a liquid ejection head comprises a plurality of nozzles through which liquid is ejected, a plurality of pressure chambers that respectively communicate with the nozzles, volumes of the pressure chambers being varied to eject the liquid through the corresponding nozzles, a substrate including an electrode on a surface of the substrate, an actuator connected to the electrode and configured to vary the volumes of the pressure chambers independently according to drive waveforms applied through the electrode, the actuator having a first side surface connected to the surface of the substrate, a first cover member that covers the first side surface of the actuator and includes a plurality of openings each facing a corresponding one of the pressure chambers, the openings having larger fluid resistance than the pressure chambers, an insulating material between the surface of the substrate and the first cover member, and an insulating film that covers the electrode on the substrate.

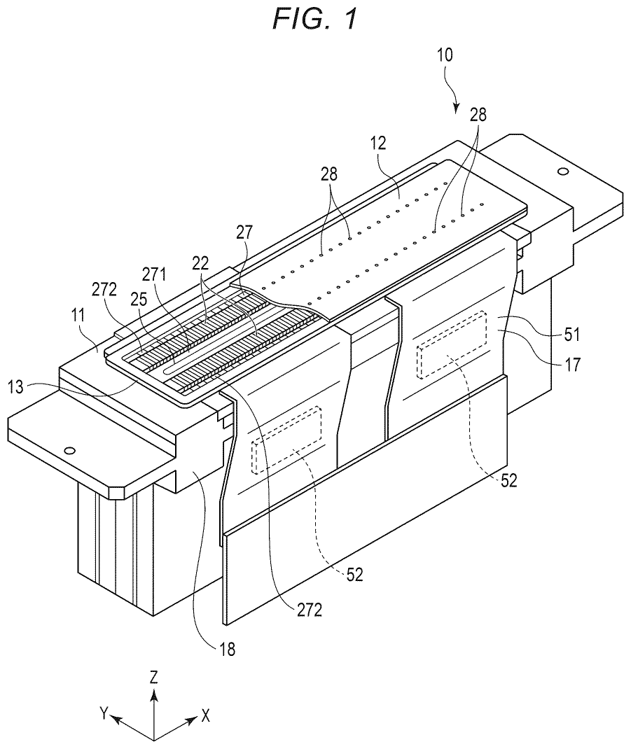

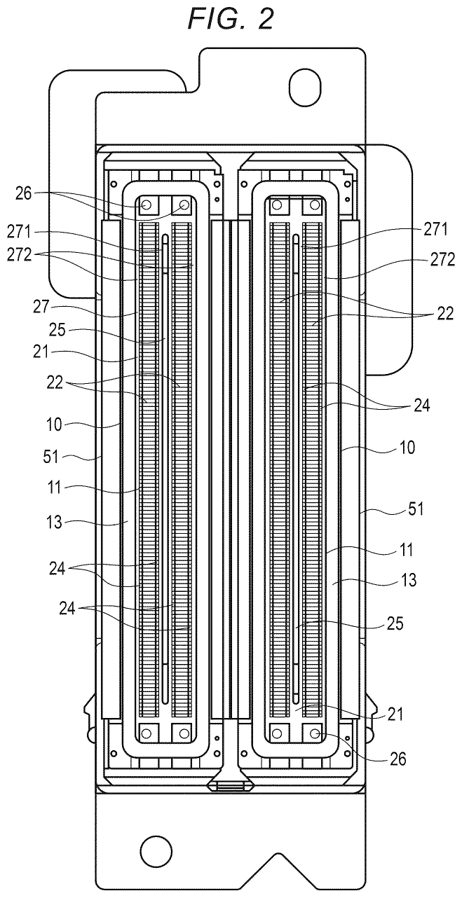

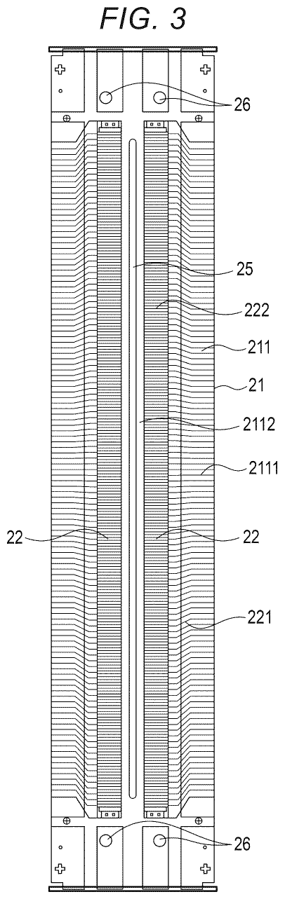

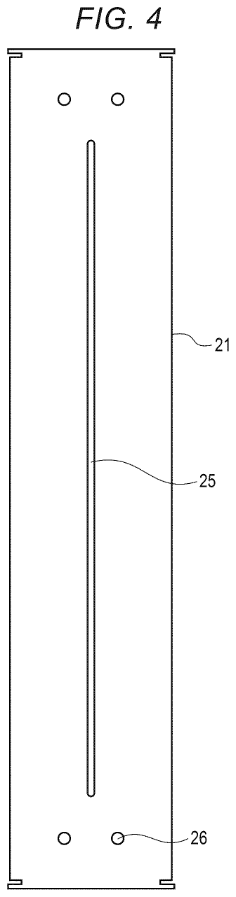

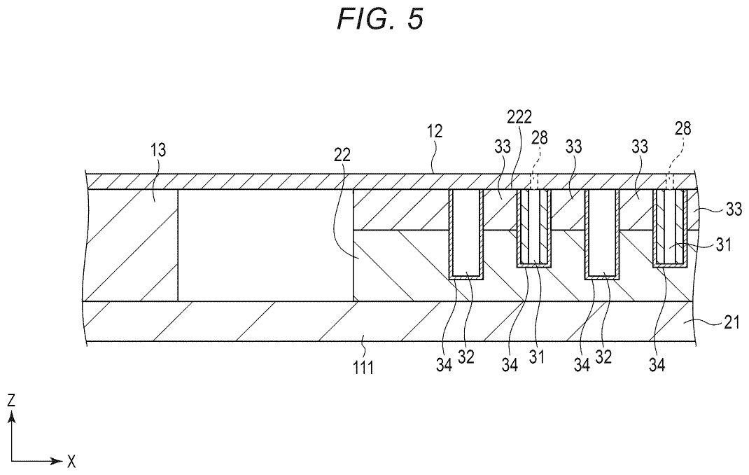

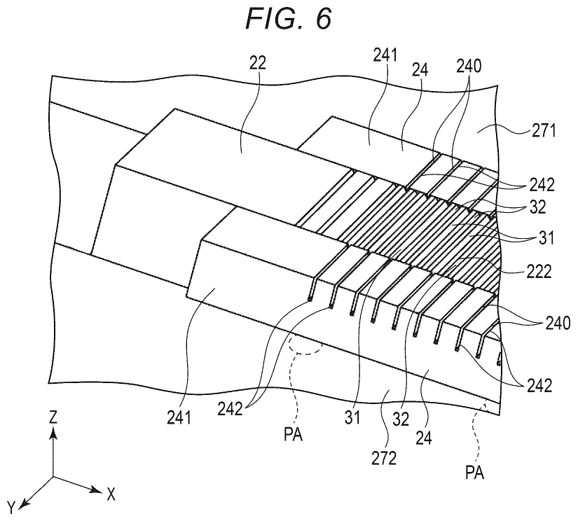

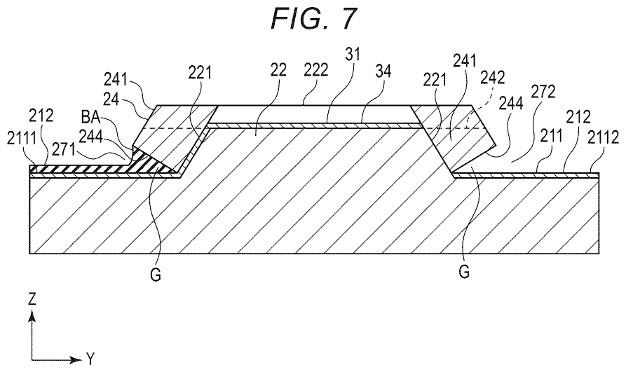

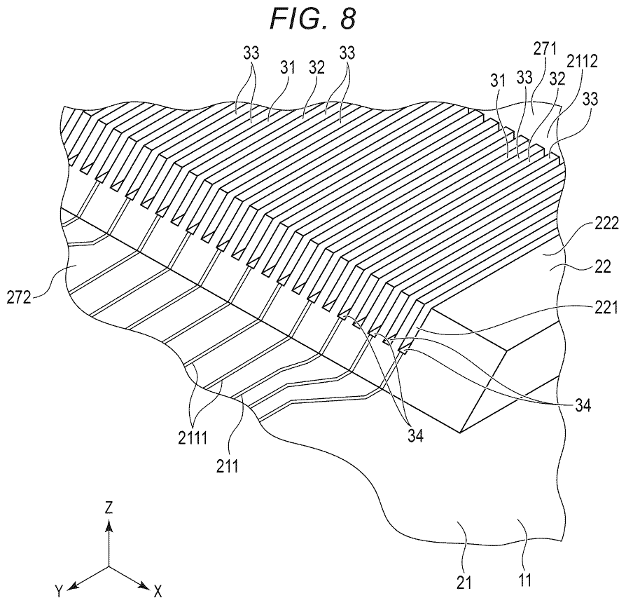

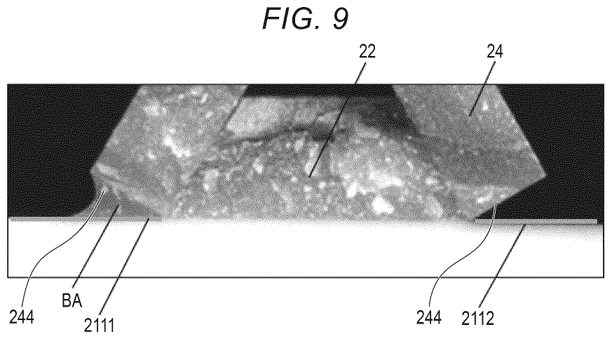

Hereinafter, a configuration of an ink jet head 10 which is a liquid ejection head according to a first embodiment will be described with reference to FIGS. 1 to 6. FIG. 1 is a perspective view illustrating the ink jet head according to the first embodiment. FIG. 2 illustrates a head unit 130 including a pair of the ink jet heads 10. FIG. 3 is a plan view illustrating a configuration of a substrate 21 and an actuator 22, and FIG. 4 is a bottom view illustrating an actuator base 11. FIG. 5 is a cross-sectional view illustrating a configuration of a part of the ink jet head 10. FIG. 6 is a perspective view and FIG. 7 is a cross-sectional view illustrating a configuration of the actuator base 11. In FIG. 6, pattern wiring 211 is omitted. FIG. 8 is a view illustrating a manufacturing process of the ink jet head 10. FIG. 9 is a view illustrating a configuration of the actuator base 11, and is a cross-sectional image illustrating a state before an insulating film 212 is formed.

In the drawings, X, Y, and Z indicate a first direction, a second direction, and a third direction orthogonal to one another. Although directions are described with reference to postures in which a row direction of nozzles 28 and pressure chambers 31 of the ink jet head 10 is along X axis, an extending direction of the pressure chamber 31 is along Y axis, and a liquid ejection direction is along Z axis, the embodiments described herein are not limited thereto.

As illustrated in FIGS. 1 to 7, the ink jet head 10 is an ink jet head of a so-called side shooter type and a shear mode shared wall type. For example, as illustrated in FIG. 2, two ink jet heads 10 each having a pair of actuators may be combined to form a head unit having a four-row integrated structure. The ink jet head 10 is a device for ejecting ink, and is, for example, mounted inside an ink jet printer. In FIG. 1 and the like, only one head main body of the ink jet head 10 is illustrated. For example, the ink jet head 10 is an independently driven ink jet head in which the pressure chambers 31 and dummy chambers 32 are alternately arranged. The dummy chamber 32 is an air chamber to which no ink is supplied, and does not include the nozzle 28.

The ink jet head 10 includes the actuator base 11, a nozzle plate 12, and a frame 13. The actuator base 11 is an example of a base material. An ink chamber 27 to which ink is supplied is formed inside the ink jet head 10.

The ink jet head 10 further includes components such as a circuit board 17 that controls the ink jet head 10 and a manifold 18 that forms a part of a path between the ink jet head 10 and an ink tank.

The actuator base 11 includes the substrate 21, a pair of the actuators 22, and a cover member 24.

The substrate 21 is formed in a rectangular plate shape, and is formed of ceramics such as alumina. The substrate 21 has a flat mounting surface. The pair of actuators 22 are joined to the mounting surface of the substrate 21. A supply hole 25 and a discharge hole 26 are formed in the substrate 21.

The pattern wiring 211 (hereinafter also referred to as the electrode wiring 211) as an electrode is formed on the substrate 21 of the actuator base 11. The pattern wiring 211 is formed of, for example, a nickel thin film. The pattern wiring 211 includes individual wiring 2111 and common wiring 2112, and is formed in a predetermined pattern shape connected to electrode layers 34 formed in the actuator 22. For example, the individual wiring 2111 of the pattern wiring 211 is formed on a surface of the substrate 21 in regions outside two rows of the actuators 22 arranged to face each other in the extending direction. The common wiring 2112 is formed, for example, in a region inside the pair of actuators 22 arranged to face each other in the extending direction, or in the supply hole 25, or on a back surface of the substrate 21.

The insulating film 212 is formed on the substrate 21 of the actuator base 11. The insulating film 212 is formed, for example, on the pattern wiring 211 on the substrate 21. For example, an adhesive is applied by spray coating or the like to form the insulating film 212.

The supply hole 25 is a through hole extending along a longitudinal direction of the actuator 22 between the pair of actuators 22 and in a central portion of the substrate 21. The supply hole 25 communicates with an ink supply portion of the manifold 18. The supply hole 25 is coupled to an ink tank via the ink supply portion. The supply hole 25 supplies ink in the ink tank to the ink chamber 27.

The discharge hole 26 is an outlet through which ink is discharged. The discharge hole 26 is a through hole that passes through the substrate 21, and a plurality of the discharge holes 26 are provided, for example, four discharge holes 26 are provided. The discharge hole 26 communicates with an ink discharge portion of the manifold 18 and discharges the ink in the ink chamber 27.

The pair of actuators 22 are joined to a mounting surface of the substrate 21. The pair of actuators 22 are arranged in two rows on the substrate 21 with the supply hole 25 interposed therebetween. Each actuator 22 is formed of two plate- shaped piezoelectric bodies made of, for example, lead zirconate titanate (PZT). The two piezoelectric bodies are attached to each other such that polarization directions are opposite to each other in a thickness direction. The actuators 22 are joined to the mounting surface of the substrate 21 with, for example, a thermosetting epoxy-based adhesive.

The actuators 22 are arranged in parallel in the ink chamber 27 at positions corresponding to the nozzles 28 arranged in two rows. The actuator 22 partitions the ink chamber 27 into a first common chamber 271 and two second common chambers 272.

The actuator 22 is formed to have a trapezoidal cross section. A longitudinal direction of a side surface portion 221 of the actuator 22 extends along the row direction, and has an inclined surface inclined relative to the extending direction and the ejection direction. That is, the actuator 22 is formed to have a trapezoidal shape in a cross-sectional view orthogonal to the row direction. A top portion 222 of the actuator 22 is joined to the nozzle plate 12. The actuator 22 includes a plurality of the pressure chambers 31 and a plurality of the dummy chambers 32. The actuator 22 includes a plurality of side wall portions 33, and includes grooves for forming the pressure chambers 31 and the dummy chambers 32 between the side wall portions 33. In other words, the side wall portion 33 is formed as a drive element between the grooves for forming the pressure chambers 31 and the dummy chambers 32.

As illustrated in FIGS. 1 to 6, a bottom surface portion of the groove and a main surface of the substrate 21 are coupled by the inclined side surface portion 221. The pressure chambers 31 and the dummy chambers 32 are alternately arranged. The pressure chambers 31 and the dummy chambers 32 each extend in a direction intersecting the longitudinal direction of the actuator 22, and a plurality of the pressure chambers 31 and a plurality of the dummy chambers 32 are arranged in parallel in the first direction (i.e., along X axis in the drawing) which is the longitudinal direction of the actuator 22.

A shape of the pressure chamber 31 and a shape of the dummy chamber 32 may be different. The side wall portion 33 is formed between the pressure chamber 31 and the dummy chamber 32, and is deformed according to a drive signal to change a volume of the pressure chamber 31.

The plurality of pressure chambers 31 communicate with a plurality of the nozzles 28 in the nozzle plate 12 joined to the top portion 222. Both ends of the pressure chamber 31 in the second direction communicate with the ink chamber 27. That is, one end portion opens to the first common chamber 271 of the ink chamber 27, and the other end portion opens to the second common chamber 272 of the ink chamber 27. Therefore, ink flows in from the one end portion of the pressure chambers 31, and the ink flows out from the other end portion. The pressure chamber 31 includes a throttle portion 240 where openings at both ends in the second direction are partially closed by the cover member 24 to increase flow path resistance. The throttle portion 240 increases fluid resistance by, for example, reducing a cross-sectional area of a flow path of the pressure chamber 31 orthogonal to the second direction to be smaller than that in the pressure chamber 31. The throttle portion 240 is configured such that a width dimension in a direction intersecting the second direction which is the extending direction of the pressure chamber 31, for example, in the first direction or the third direction is narrowed at an inlet and an outlet at both ends of the pressure chamber 31. For example, the throttle portion 240 is formed by closing a part of a flow path between the pressure chamber 31 and the ink chamber 27 by providing the cover member 24 that closes a flow path of the pressure chamber 31.

One side of the dummy chamber 32 in the third direction is closed by the nozzle plate 12 joined to the top portion 222, and both sides of the dummy chamber 32 in the second direction are closed by the cover member 24.

The cover member 24 includes a cover plate 241 having a predetermined thickness. The cover plate 241 is attached to a side surface of the actuator 22. The cover plate 241 is formed with throttle holes 242 as a plurality of throttle holes passing through the cover plate 241 in the thickness direction. The cover member 24 is provided at both ends of the actuator 22 in the second direction, and closes an opening of the dummy chamber 32 and a part of an opening of the pressure chamber.

The grooves for forming the pressure chambers 31 communicate with the first common chamber 271 and the second common chamber 272 through the throttle holes 242 formed in the cover member 24. The throttle hole 242 is, for example, an opening having a cross-sectional area smaller than that of the pressure chamber, and for example, is formed by a slit-shaped groove that opens toward the nozzle plate 12.

The cover member 24 closes a part of each opening that communicates with the first common chamber 271 and the second common chamber 272 which are common chambers at both ends of the pressure chamber 31, thereby forming the throttle portion 240 having larger fluid resistance than the pressure chamber 31.

The cover member 24 is joined to the inclined side surface portion 221 of the actuator 22. One end edge of the cover member 24 may be joined to the substrate 21.

The cover member 24 is formed by, for example, attaching one main surface of a plate member having a rectangular cross section along the side surface portion 221 which is an inclined surface, and removing by cutting or the like a part on a side close to the nozzle plate 12, so that, for example, a side is formed to have a trapezoidal cross-sectional shape having an inclined surface. Accordingly, of the cover member 24 attached to the inclined side surface portion 221 of the actuator 22, an end surface 244 on a side close to the substrate 21 is inclined relative to a main surface of the substrate 21, and a gap G is formed between the end surface 244 of the cover member 24 on the side close to the substrate 21 and an upper surface of the substrate 21. For example, an outer side of the end surface 244 in the extending direction is inclined away from the substrate 21, and the gap G is formed in a shape in which an outer side in the extending direction is widened.

The gap G is filled with an adhesive BA. For example, a dimension of the gap G is set under a dimension condition such that the adhesive BA can be drawn into the gap G by capillary action and can be held in the gap G until the filled adhesive BA is cured according to physical properties such as viscosity of the adhesive BA.

The adhesive BA is an insulating material, and is formed of, for example, the same material as the insulating film 212 formed on the substrate 21. The adhesive BA is continuous with the insulating film 212 on the substrate 21 and forms a protective layer for protecting the pattern wiring 211.

When the fluid resistance at the throttle portion 240 is too large, replenishment of ink to the pressure chamber 31 after ink droplets are ejected slows down, which hinders speeding up. The swelling of the meniscus is different depending on ink viscosity, an ejection volume, a drive frequency, and the like. Accordingly, a thickness of the cover member 24 and a dimension and a position of the throttle hole 242 of the throttle portion 240 are set to obtain flow path resistance according to an ink replenishment condition and swelling characteristics of the meniscus.

Both ends of each of the plurality of dummy chambers 32 are closed by, for example, the cover member 24. That is, the cover member 24 is disposed between the first common chamber 271 of the ink chamber 27 and an inlet of the dummy chamber 32 and between an outlet of the dummy chamber 32 and the second common chamber 272, and both ends of the dummy chamber 32 are separated from the ink chamber 27. Therefore, the dummy chamber 32 forms an air chamber into which no ink flows.

The electrode layer 34 is provided in each of the pressure chamber 31 and the dummy chamber 32 of the actuator base 11. The electrode layer 34 is formed of, for example, a nickel thin film. The electrode layer 34 extends from a bottom portion of the groove to above the substrate 21, and is connected to the pattern wiring 211. For example, the electrode layer 34 of the pressure chamber 31 is connected to the individual wiring 2111 on the mounting surface of the actuator base 11 and forms an individual electrode. The electrode layer 34 of the dummy chamber 32 is connected to the common wiring 2112 on the mounting surface of the actuator base 11 and forms a common electrode.

The nozzle plate 12 is formed of, for example, a rectangular film made of polyimide. The nozzle plate 12 faces the mounting surface of the actuator base 11. A plurality of the nozzles 28 that pass through the nozzle plate 12 in the thickness direction are formed in the nozzle plate 12.

The number of the plurality of the nozzles 28 are the same as the number of the pressure chambers 31, and the nozzles 28 are disposed in a manner of facing the pressure chambers 31. The plurality of nozzles 28 are arranged in the first direction, and are arranged in two rows corresponding to the pair of actuators 22. Each nozzle 28 is formed in a cylindrical shape with an axis extending in the third direction. For example, a diameter of the nozzle 28 may be constant, or the diameter of the nozzle 28 may be reduced toward a central portion or a tip end portion. The nozzle 28 is disposed in a manner of facing an intermediate portion in the extending direction of the pressure chamber 31 formed in each of the pair of actuators 22, and communicates with the pressure chamber 31. One nozzle 28 is disposed in one pressure chamber 31 at a central portion in the longitudinal direction.

The frame 13 is formed of, for example, a nickel alloy, and is formed in a rectangular frame shape. The frame 13 is interposed between the mounting surface of the actuator base 11 and the nozzle plate 12. The frame 13 is joined to the mounting surface of the actuator base 11 and the nozzle plate 12. That is, the nozzle plate 12 is attached to the actuator base 11 via the frame 13.

The manifold 18 is joined to the actuator base 11 on a side opposite to the nozzle plate 12. An ink supply portion which is a flow path communicating with the supply hole 25 and an ink discharge portion which is a flow path communicating with the discharge hole 26 are formed inside the manifold 18.

The circuit board 17 is a film carrier package (FCP). The circuit board 17 includes a flexible resin film 51 on which a plurality of wires are formed, and an IC 52 connected to the plurality of wires of the film 51. The IC 52 is electrically connected to the electrode layer 34 via the wires of the film 51 and the pattern wiring 211.

In the ink jet head 10 configured as described above, the ink chamber 27 surrounded by the actuator base 11, the nozzle plate 12, and the frame 13 is formed. That is, the ink chamber 27 is formed between the actuator base 11 and the nozzle plate 12. For example, the ink chamber 27 is divided into three sections in the second direction by the two actuators 22, and includes the two second common chambers 272 serving as common chambers into which the discharge hole 26 opens, and the first common chamber 271 serving as a common chamber into which the supply hole 25 opens. The first common chamber 271 and the second common chamber 272 communicate with the plurality of pressure chambers 31.

In the ink jet head 10 configured as described above, ink circulates between the ink tank and the ink chamber 27 through the supply hole, the pressure chamber, and the discharge hole. For example, in response to a signal input from a control unit of an ink jet printer, the drive IC 52 applies a drive voltage to the electrode layer 34 via the wires of the film 51, thereby generating a voltage difference between the electrode layer 34 of the pressure chamber 31 and the electrode layer 34 of the dummy chamber 32 to selectively deform the side wall portion 33 in a shear mode. The volume of the pressure chamber 31 is changed by deforming the side wall portion 33 formed between the pressure chamber 31 and the dummy chamber 32 according to a drive signal.

When the side wall portion 33 is deformed in the shear mode, the volume of the predetermined pressure chamber 31 is increased and pressure is reduced. Accordingly, ink in the ink chamber 27 flows into the pressure chamber 31.

In a state where the volume of the pressure chamber 31 is increased, the IC 52 applies a drive voltage of a negative voltage to the electrode layer 34. Accordingly, the side wall portion 33 is deformed in the shear mode, the volume of the pressure chamber 31 is reduced, and pressure is increased. Accordingly, ink in the pressure chamber 31 is pressurized and ejected from the nozzle 28.

A method for manufacturing the ink jet head 10 will be described. First, a plurality of piezoelectric members are attached to the plate-shaped substrate 21 with an adhesive or the like, and grooves are formed by machining using a dicing saw, a slicer, or the like to form the actuator base 11 having a predetermined outer shape. For example, a plurality of the actuator bases 11 each having a predetermined shape may be manufactured by forming a block-shaped base member having a thickness corresponding to that of a plurality of members in advance and then dividing the base member.

Subsequently, the electrode layer 34 and the pattern wiring 211 are formed on inner surfaces of the grooves for forming the pressure chambers 31 and the dummy chambers 32 and a surface of the substrate 21. Through the above processing, as illustrated in FIG. 8, the electrode layer 34 and the pattern wiring 211 are formed at predetermined positions, and the actuator 22 including the pressure chambers 31 and the dummy chambers 32 is formed. Then, as illustrated in FIG. 6, the cover member 24 that is formed in a plate shape and is formed with the plurality of throttle holes 242 is joined to the side surface portions 221 on both sides of the actuator 22 where the pressure chambers 31 and the dummy chambers 32 are opened. For example, the cover member 24 is formed by forming the plurality of throttle holes 242 narrower than an inner side of the pressure chamber 31 in the cover plate 241 that is formed in a plate shape in advance and is formed of an insulating material. The cover plate 241 is a molded part formed in a plate shape and formed of a ceramic material such as zirconia and alumina, and is formed, by laser processing or machining, with slits that are to be formed as the throttle holes 242 having flow path resistance larger than that of the ink chamber.

As described above, by attaching the cover member 24 that is formed with the throttle holes 242 in advance and is formed in a plate shape, the opening of the dummy chamber 32 is covered, and the opening of the pressure chamber 31 is partially covered while communicating with the common chamber 271 and the common chamber 272 through the throttle hole 242 having a flow path cross-sectional area smaller than that of an inner side of the pressure chamber 31.

The cover member 24 is formed by attaching, for example, a plate-shaped member having a rectangular cross section in a manner in which one main surface of the plate-shaped member is along the inclined side surface portion 221, and then removing a part of the plate-shaped member on a side close to the nozzle plate 12 by cutting or the like. Accordingly, of the cover member 24 attached to the inclined side surface portion 221 of the actuator 22, the end surface 244 on a side close to the substrate 21 is inclined relative to a main surface of the substrate 21, and the gap G is formed between the end surface 244 of the cover member 24 on the side close to the substrate 21 and an upper surface of the substrate 21. For example, an outer side of the end surface 244 in the extending direction is inclined away from the substrate 21, and the gap G is formed in a shape in which an outer side in the extending direction is widened.

Subsequently, the gap G is filled with the adhesive BA that is an insulating material. Specifically, the adhesive BA is applied to a predetermined position slightly outside the gap G, and then the adhesive BA is left naturally for a predetermined period of time, so that the adhesive BA is drawn into the gap G by capillary action. For example, when the adhesive BA is applied on the entire surface, since air bubbles are mixed and confined in the gap G, the adhesive BA is supplied at intervals to allow the air bubbles to escape. For example, as illustrated in FIG. 6, the adhesive BA is dot applied at a plurality of supply points PA. The supply points PA are arranged at a plurality of positions, for example, six positions in each row in the gap G or in the vicinity of an inlet of the gap G for each gap G that is long in the X direction.

As illustrated in FIGS. 7 and 9, the adhesive BA is filled in the gap G formed in a portion of the substrate 21 where at least the individual electrode is formed. For example, the adhesive BA may be filled in both of the gaps G on both side portions of the actuator 22, or may be filled only in the gap G on one side portion where the individual electrode is formed. Then, the adhesive BA is left naturally for a while until the adhesive is filled in the gap G by capillary action, and then the adhesive BA in the gap G is baked by being thermally cured.

Next, the adhesive BA that is an insulating material is applied by being sprayed on the electrode wiring 211 on the substrate 21 in a region outside the gap G to form the insulating film 212. Specifically, the adhesive BA is applied from above the electrode wiring 211 by spraying or the like, and is baked by being thermally cured. At this time, the insulating film 212 is made continuous with the adhesive BA filled in the gap G, so that the electrode wiring 211 on the substrate 21 including the gap G is protected by the insulating film 212 and the adhesive BA. The insulating film 212 may enter the gap G.

Further, the actuator base 11 is assembled to the manifold 18, and the frame 13 is attached to one surface of the substrate 21 of the actuator base 11 by an adhesive sheet of a thermoplastic resin.

Then, the assembled frame 13, the top portion 222 of the side wall portion 33 of the actuator 22, and a surface of the cover member 24 on a side close to the nozzle plate 12 are polished to be the same surface. That is, a top surface of the actuator 22 and a top surface of the cover member 24 become continuous. Then, the nozzle plate 12 is attached by being joined to the polished surface of the top portion 222 of the side wall portion 33, the frame 13, and the cover member 24. At this time, the nozzles 28 are positioned in a manner of facing the pressure chambers 31. Further, as illustrated in FIG. 1, the drive IC chip 52 and the circuit board 17 are connected to the pattern wiring 211 formed on a main surface of the substrate 21 via a flexible printed board to finish the ink jet head 10.

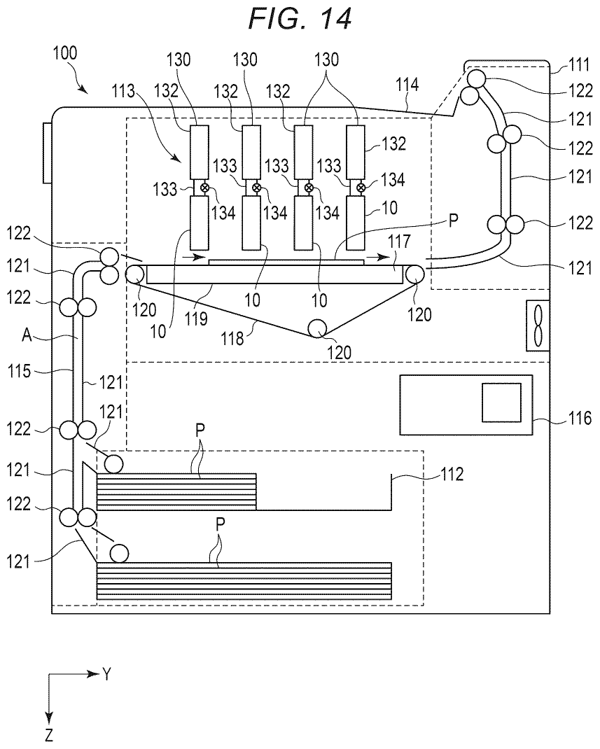

Hereinafter, an example of an ink jet printer 100 including the ink jet head 10 will be described with reference to FIG. 14. The ink jet printer 100 includes a housing 111, a medium supply unit 112, an image forming unit 113, a medium discharge unit 114, a conveyance device 115, and a control unit 116.

The ink jet printer 100 is a liquid ejection apparatus that ejects a liquid such as ink while conveying a recording medium that is an ejection target such as a sheet P along a predetermined conveyance path A from the medium supply unit 112 to the medium discharge unit 114 through the image forming unit 113, and thereby executes image forming processing on the sheet P.

The housing 111 constitutes an outer shell of the ink jet printer 100. A discharge port through which the sheet P is to be discharged to the outside is provided at a predetermined position of the housing 111.

The medium supply unit 112 includes a plurality of sheet feed cassettes, and can store a plurality of sheets P of various sizes in a manner of stacking the sheets P.

The medium discharge unit 114 includes a sheet discharge tray that can hold the sheet P discharged from the discharge port.

The image forming unit 113 includes a holding portion 117 that holds the sheet P, and a plurality of head units 130 that are disposed in a manner of facing the holding portion 117 above the holding portion 117.

The holding portion 117 includes a conveyance belt 118 provided in a loop shape in a predetermined region where image formation is performed, a support plate 119 that supports the conveyance belt 118 from a back side, and a plurality of belt rollers 120 provided on the back side of the conveyance belt 118.

During image formation, the holding portion 117 supports the sheet P on a holding surface that is an upper surface of the conveyance belt 118, and conveys the sheet P to a downstream side by sending the conveyance belt 118 at a predetermined timing by rotation of the belt rollers 120.

The head unit 130 includes a plurality of ink jet heads 10, ink tanks 132 as liquid tanks respectively mounted on the ink jet heads 10, connection flow paths 133 that connect the ink jet heads 10 and the ink tanks 132, and circulation pumps 134 that are circulation portions. The head unit 130 is a circulation type head unit that causes liquid to constantly circulate in the ink tank 132, and the pressure chamber 31, the dummy chamber 32, and the ink chamber 27 that are formed inside the ink jet head 10.

In the present example, the ink jet heads 10 of four colors: cyan, magenta, yellow, and black, and the ink tanks 132 that respectively store ink of these colors are provided. The ink tank 132 is connected to the ink jet head 10 by the connection flow path 133. The connection flow path 133 includes a supply flow path connected to a supply port of the ink jet head 10 and a collection flow path connected to a discharge port of the ink jet head 10.

A negative pressure control device such as a pump (not illustrated) is connected to the ink tank 132. A negative pressure in the ink tank 132 is controlled by the negative pressure control device according to water head values of the ink jet head 10 and the ink tank 132, thereby forming the ink supplied to each nozzle 28 of the ink jet head 10 into a meniscus having a predetermined shape.

The circulation pump 134 is, for example, a liquid sending pump formed of a piezoelectric pump. The circulation pump 134 is provided in a supply flow path. The circulation pump 134 is connected to a drive circuit of the control unit 116 through wiring, and is configured to be controllable under the control of a central processing unit (CPU). The circulation pump 134 causes a liquid to circulate in a circulation flow path including the ink jet head 10 and the ink tank 132.

The conveyance device 115 conveys the sheet P along the conveyance path A from the medium supply unit 112 to the medium discharge unit 114 through the image forming unit 113. The conveyance device 115 includes a plurality of guide plate pairs 121 disposed along the conveyance path A and a plurality of conveyance rollers 122.

Each of the plurality of guide plate pairs 121 includes a pair of plate members disposed in a manner of facing each other across the sheet P to be conveyed, and guides the sheet P along the conveyance path A.

The conveyance roller 122 is driven and rotated under the control of the control unit 116, thereby conveying the sheet P to the downstream side along the conveyance path A. Sensors that detect a sheet conveyance state are disposed at various positions in the conveyance path A.

The control unit 116 includes a control circuit such as a CPU serving as a controller, a read only memory (ROM) that stores various programs, a random access memory (RAM) that temporarily stores various kinds of variable data, image data, and the like, and an interface unit that receives data from the outside and outputs data to the outside.

In the ink jet printer 100 configured as described above, for example, when the control unit 116 detects a print instruction that is input by a user operating an operation input unit at an interface, the control unit 116 drives the ink jet head 10 by driving the conveyance device 115 to convey the sheet P and outputting a printing signal to the head unit 130 at a predetermined timing. As an ejection operation, the ink jet head 10 transmits a drive signal to the IC according to an image signal corresponding to image data, and applies a drive voltage to the electrode layer 34 of the actuator 22 via wiring to selectively drive the side wall portion 33 of the actuator 22, thereby ejecting ink from the nozzle 28 and forming an image on the sheet P held on the conveyance belt 118. As a liquid ejection operation, the control unit 116 drives the circulation pump 134 to circulate the liquid in a circulation flow path passing through the ink tank 132 and the ink jet head 10. By a circulation operation, the ink in the ink tank 132 is supplied from the supply hole 25 to the first common chamber 271 of the ink chamber 27 through the ink supply portion of the manifold 18 by driving the circulation pump 134. The ink is supplied to the plurality of pressure chambers 31 and the plurality of dummy chambers 32 of the pair of actuators 22. The ink flows into the second common chamber 272 of the ink chamber 27 through the pressure chamber 31 and the dummy chamber 32. The ink is discharged from the discharge hole 26 to the ink tank 132 through the ink discharge portion of the manifold 18.

According to the configuration of the ink jet head 10 described above, a protective layer can be formed by drawing, by capillary action, the adhesive BA into the gap G on a lower side of the cover member 24 disposed on a side wall of the actuator 22. That is, for example, when an insulating film made of an adhesive is sprayed on an electrode formation surface of a head substrate using a spray or the like, the cover plate 241 acts as an eaves, and the pattern wiring that is the electrode wiring in the gap G cannot be insulated and protected. However, an insulating property can be easily ensured by setting a dimension of the gap G such that the adhesive is drawn into the gap G by capillary action.

Further, since the gap G is formed to have a size at which the adhesive can be drawn into the gap G by capillary reduction and can be held in the gap G, an insulating portion can be formed reliably and the pattern wiring can be insulated and protected. Accordingly, when conductive ink is filled in the head 10 and a voltage is applied, it is possible to prevent conductive substances in the ink from precipitating onto the pattern wiring and causing a short circuit in the pattern wiring.

According to the configuration described above, an ink jet head having high frequency characteristics can be provided. That is, in the ink jet head 10 described above, since the pressure chamber 31 is provided with the cover member 24, an inlet and an outlet of the pressure chamber 31 have larger flow path resistance than the inner side of the pressure chamber 31, the first common chamber 271, and the second common chamber 272. For example, openings that open to the first common chamber 271 and the second common chamber 272 which are common chambers of the pressure chamber 31 have smaller flow path cross-sectional areas than that of the pressure chamber 31. Therefore, swelling of the meniscus is reduced when the liquid is ejected in the ink jet head 10. Therefore, the meniscus can be recovered quickly, an influence on a subsequent ink droplet can be reduced, and ejection stability can be improved.

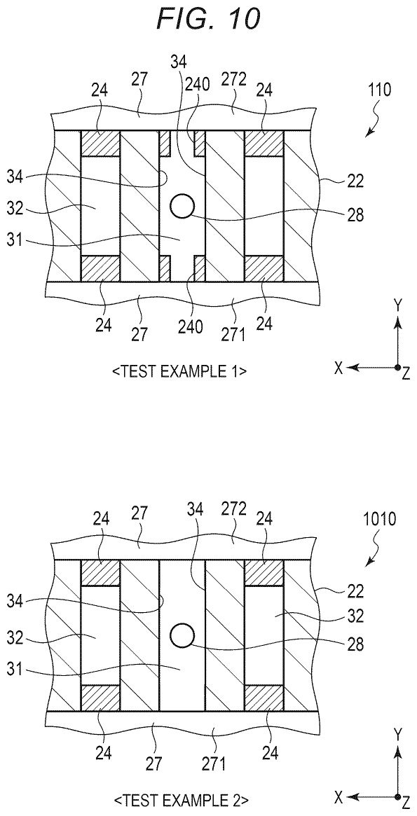

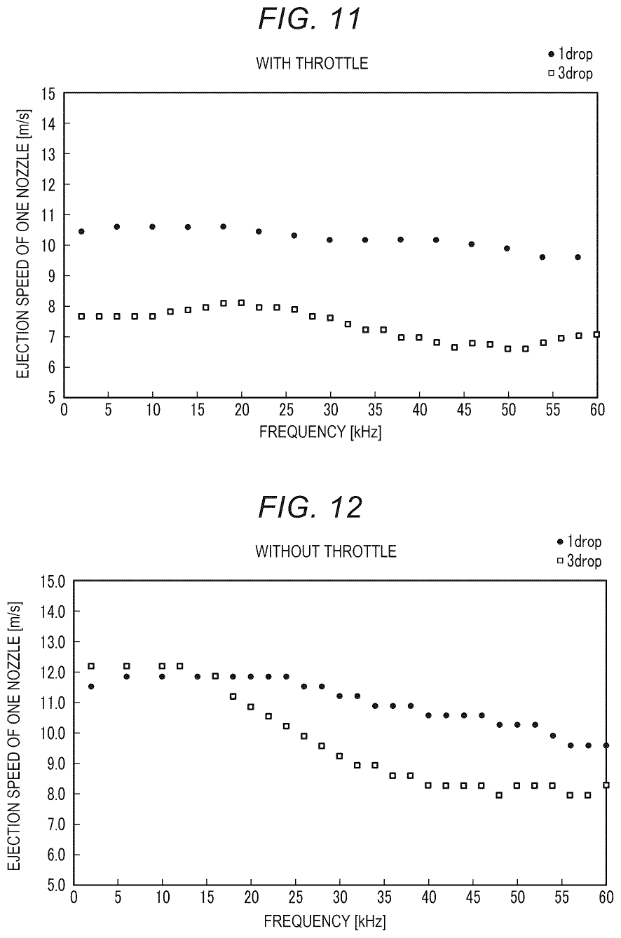

FIG. 10 shows Test Example 1 of an ink jet head 110 that is provided with a throttle portion 240 (hereinafter also referred to as a throttle) and Test Example 2 of an ink jet head 1010 that is not provided with any throttle. FIG. 11 shows frequency characteristics of the ink jet head 110 that is provided with a throttle according to Test Example 1, and FIG. 12 shows frequency characteristics of the ink jet head 1010 that is not provided with a throttle according to Test Example 2. In FIGS. 11 and 12, a relationship between an ejection speed of a nozzle and a frequency is illustrated for each case of 1 drop and 3 drop.

The ink jet heads 110 and 1010 according to Test Example 1 and Test Example 2 are ink jet heads of a side shooter type in which both sides of the pressure chamber 31 in the second direction which is the extending direction communicate with the common chamber, and the nozzle 28 opens at an intermediate portion of the pressure chamber 31 in the extending direction. Each of the ink jet heads 110 and 1010 according to Test Example 1 and Test Example 2 includes a plurality of the pressure chambers 31 in which the electrode layer 34 is formed on an inner wall surface and a plurality of the dummy chambers 32, the plurality of pressure chambers 31 and the plurality of dummy chambers 32 being alternately arranged, and both ends of each of the dummy chambers 32 in the extending direction are closed by the cover member 24.

As illustrated in FIG. 12, in the ink jet head 1010 according to Test Example 2, an ejection speed is flat in a low-frequency region, the ejection speed tends to decrease as the frequency increases, and there is a difference in the ejection speed between the low-frequency region and a high-frequency region. In the case of 1 drop of the ink jet head 1010 according to Test Example 2, the ejection speed is flat up to 25 kHz, and the ejection speed tends to decrease as the frequency increases to be 25 kHz or more. In the case of 3 drop of the ink jet head 1010 according to Test Example 2, the ejection speed is flat up to 15 kHz, and the ejection speed tends to decrease as the frequency increases to be 15 kHz or more. Therefore, landing positions vary depending on a printing pattern. When the difference in the ejection speed is large as described above, it takes time for the swelling of the meniscus to subside, which causes deterioration in printing quality, and thus high-speed driving cannot be achieved.

On the other hand, as illustrated in FIG. 11, in the ink jet head 110 including the throttle portion 240, the ejection speed tends to be flat for both cases of 1 drop and 3 drop. This is because fluid resistance between nozzles increases from a common liquid, and the swelling of the meniscus decreases.

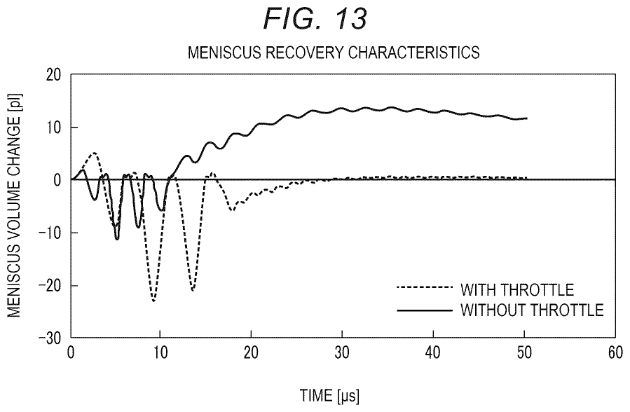

FIG. 13 shows simulation results of meniscus recovery in Test Example 1 in which the throttle is provided in the pressure chamber and Test Example 2 in which no throttle is provided. According to FIG. 13, when a meniscus state of a nozzle is a low frequency, there is sufficient time from ejection of an ink droplet to subsequent ejection, and it is possible to eject ink in a stable state after waiting for the recovery of the meniscus regardless of whether the throttle is provided. On the other hand, in the case of a high frequency, since a time from ejection of dots (i.e., ink droplets) to subsequent ejection is short, the subsequent ejection starts before the meniscus is recovered. Therefore, in the case of the ink jet head 1010 that is not provided with a throttle, the swelling of the meniscus becomes large after ejection, the meniscus cannot be recovered before the subsequent ejection, and an ejection speed decreases. On the other hand, when the throttle is provided, since the swelling of the meniscus is small, the meniscus can be quickly recovered and an influence on the subsequent ejection can be reduced. Accordingly, based on the simulation results, it can be said that ejection stability of the ink jet head 110 can be improved by providing a throttle between the pressure chamber 31 and the common chamber.

By attaching, to the actuator 22, the cover member 24 in which throttle ports are formed in advance, it is possible to easily form a throttle with high accuracy and with fewer assembling steps.

### Second Embodiment

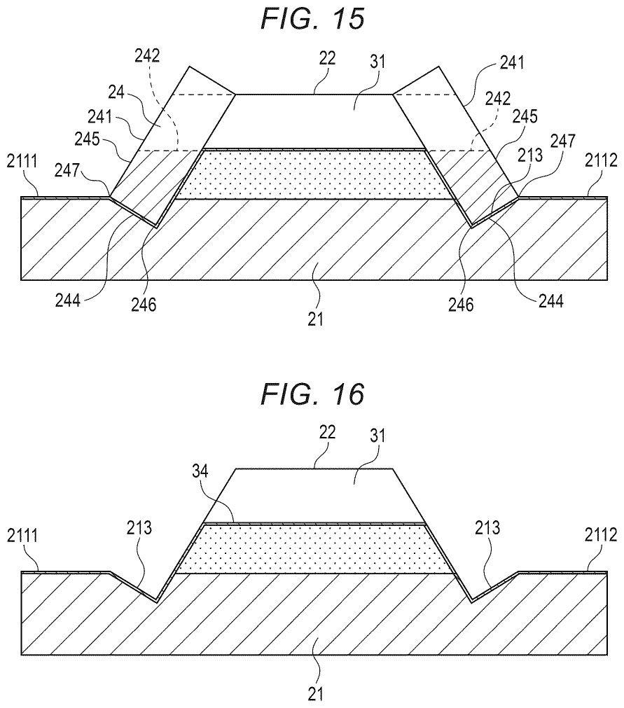

Hereinafter, a configuration of an ink jet head 20 which is a liquid ejection head according to a second embodiment will be described with reference to FIGS. 1 to 5 and FIGS. 15 and 16. FIG. 15 is a cross-sectional view illustrating a configuration of the actuator base 11 of the ink jet head 20 according to the second embodiment, and FIG. 16 is a cross-sectional view illustrating a configuration of the substrate 21 and the actuator 22.

The ink jet head 20 according to the present embodiment is different from the ink jet head 10 according to the first embodiment in that a part of the cover member 24 is embedded in the substrate 21 and the substrate 21 includes a groove in which an end portion of the cover member 24 is disposed. Configurations other than the arrangement of the cover member 24 and the substrate 21 are the same as those of the ink jet head 10 according to the first embodiment.

As illustrated in FIGS. 1 to 5, the ink jet head 20 includes the actuator base 11, the nozzle plate 12, and the frame 13.

The actuator base 11 includes the substrate 21, the pair of the actuators 22, and the cover member 24.

The substrate 21 is formed in a rectangular plate shape, and is formed of ceramics such as alumina. The substrate 21 has a flat mounting surface. The pair of actuators 22 are joined to the mounting surface of the substrate 21. The supply hole 25 and the discharge hole 26 are formed in the substrate 21.

An accommodation groove 213 is formed in a portion of the substrate 21 where the actuator 22 is mounted and where the substrate 21 faces both side edges of the actuator 22. The accommodation groove 213 is a recessed portion that extends in the X direction and follows an outer shape of an end edge portion of the cover plate 241. For example, the accommodation groove 213 is a V-shaped groove, and a groove bottom is formed at 90 degrees in accordance with a shape of a corner portion 246 of the cover plate 241. The corner portion 246 of the cover plate 241 is embedded in the accommodation groove 213.

The pattern wiring 211 is formed on the substrate 21. The pattern wiring 211 is formed in a predetermined region of the substrate 21 including a V-shaped groove bottom surface of the accommodation groove 213. The pattern wiring 211 includes the individual wiring 2111 and the common wiring 2112, and is formed in a predetermined pattern shape connected to the electrode layers 34 formed in the actuator 22.

The actuator 22 is formed to have a trapezoidal cross section. The side surface portion 221 of the actuator 22 includes an inclined surface inclined relative to the second direction and the third direction. That is, the actuator 22 is formed to have a trapezoidal shape in a cross-sectional view orthogonal to the second direction. The top portion 222 of the actuator 22 is joined to the nozzle plate 12. The actuator 22 includes the plurality of pressure chambers 31 and the plurality of dummy chambers 32. The actuator 22 includes the plurality of side wall portions 33, and includes grooves for forming the pressure chambers 31 and the dummy chambers 32 between the side wall portions 33. In other words, the side wall portion 33 is formed as a drive element between the grooves for forming the pressure chambers 31 and the dummy chambers 32.

The cover member 24 includes the cover plate 241 having a predetermined thickness. The cover plate 241 has a shape corresponding to the inclined side surface portion 221 of the actuator, and for example, has a rectangular shape extending in the first direction. The cover plate 241 is formed with the throttle holes 242 as a plurality of throttle holes passing through the cover plate 241 in the thickness direction. The cover member 24 is provided at both ends of the actuator 22 in the second direction, and closes an opening of the dummy chamber 32 and a part of an opening of the pressure chamber.

The grooves for forming the pressure chambers 31 communicate with the first common chamber 271 and the second common chamber 272 through the throttle holes 242 formed in the cover member 24. The throttle hole 242 is, for example, an opening having a cross-sectional area smaller than that of the pressure chamber, and for example, is formed by a slit-shaped groove that opens toward the nozzle plate 12.

The cover member 24 closes a part of each opening that communicates with the first common chamber 271 and the second common chamber 272 which are common chambers at both ends of the pressure chamber 31, thereby forming the throttle portion 240 having larger fluid resistance than the pressure chamber 31.

The cover member 24 is joined to the inclined side surface portion 221 of the actuator 22. A part of an end edge portion of the cover member 24 on a side close to the substrate 21 is embedded in the accommodation groove 213 of the substrate 21. At least one corner portion 246 of the cover plate 241 is accommodated in the accommodation groove 213, and in the present embodiment, the entire end surface 244 on the side close to the substrate 21 is disposed in the accommodation groove 213. Accordingly, an outer main surface of the cover plate 241 and the mounting surface of the substrate 21 form an outer surface continuous at an obtuse angle.

For example, the cover member 24 is formed by attaching one main surface of a plate member having a rectangular cross section along the side surface portion 221 which is an inclined surface, and removing, by cutting or the like, a part on a side close to the nozzle plate 12, so that a side is formed to have a trapezoidal cross-sectional shape having an inclined surface. Since the end surface 244 of the cover plate 241 on the side close to the substrate 21 is embedded in the accommodation groove 213 from the one corner portion 246 to the other corner portion 247, an outer main surface 245 of the cover plate 241 and an upper surface of the substrate 21 form a continuous outer surface.

The insulating film 212 may be formed on the substrate 21 of the actuator base 11. The insulating film 212 is formed, for example, on the pattern wiring 211 on the substrate 21. For example, an adhesive is applied by spray coating or the like to form the insulating film 212.

A method for manufacturing the ink jet head 20 will be described. First, a plurality of piezoelectric members are attached to the plate-shaped substrate 21 with an adhesive or the like, grooves are formed by machining using a dicing saw, a slicer, or the like to form the actuator 22, the accommodation grooves 213 are formed in the substrate 21, and the actuator base 11 having a predetermined outer shape is formed. For example, a plurality of the actuator bases 11 each having a predetermined shape may be manufactured by forming a block-shaped base member having a thickness corresponding to that of a plurality of members in advance and then dividing the base member.

Subsequently, the electrode layer 34 and the pattern wiring 211 are formed on inner surfaces of the grooves for forming the pressure chambers 31 and the dummy chambers 32 and a surface of the substrate 21. Through the above processing, the electrode layer 34 and the pattern wiring 211 are formed at predetermined positions, and the actuator 22 including the pressure chambers 31 and the dummy chambers 32 is formed. The cover member 24 that is formed in a plate shape and is formed with the plurality of throttle holes 242 is joined to the side surface portions 221 on both sides of the actuator 22 where the pressure chambers 31 and the dummy chambers 32 are opened. For example, the cover member 24 is formed by forming the plurality of throttle holes 242 narrower than an inner side of the pressure chamber 31 in the cover plate 241 that is formed in a plate shape in advance and is formed of an insulating material. The cover plate 241 is a molded part formed in a plate shape and formed of a ceramic material such as zirconia and alumina, and is formed, by laser processing or machining, with slits that are to be formed as the throttle holes 242 having larger flow path resistance than the ink chamber.

As described above, by attaching the cover member 24 that is formed with the throttle holes 242 in advance and is formed in a plate shape, the opening of the dummy chamber 32 is covered, and the opening of the pressure chamber 31 is partially covered while communicating with the common chamber 271 and the common chamber 272 through the throttle hole 242 having a flow path cross-sectional area smaller than that of an inner side of the pressure chamber 31.

At this time, positioning can be easily performed by disposing the corner portion 246 of the cover plate 241 in the accommodation groove 213.

Next, the adhesive BA that is an insulating material is applied by being sprayed on the pattern wiring 211 on the substrate 21 to form the insulating film 212. Specifically, the adhesive BA is applied from above the pattern wiring 211 by spraying or the like, and then is baked.

Further, the actuator base 11 is assembled to the manifold 18, and the frame 13 is attached to one surface of the substrate 21 of the actuator base 11 by an adhesive sheet of a thermoplastic resin.

Then, the assembled frame 13, the top portion 222 of the side wall portion 33 of the actuator 22, and a surface of the cover member 24 on a side close to the nozzle plate 12 are polished to be the same surface. Then, the nozzle plate 12 is attached by being joined to the polished surface of the top portion 222 of the side wall portion 33, the frame 13, and the cover member 24. At this time, the nozzles 28 are positioned in a manner of facing the pressure chambers 31. Further, as illustrated in FIG. 1, the drive IC chip 52 and the circuit board 17 are connected to the pattern wiring 211 formed on a main surface of the substrate 21 via a flexible printed board to finish the ink jet head 20.

According to the ink jet head 20 of the present embodiment, the outer main surface 245 of the cover member 24 and the upper surface of the substrate 21 can be made continuous by forming the substrate 21 with the accommodation groove 213 that accommodates at least one corner portion 246 of the cover plate 241. That is, it is possible to prevent a gap or a recessed portion from being formed between the substrate 21 and the cover plate 241. Accordingly, an electrode can be insulated and protected by the insulating film 212 formed by spray coating, and a short circuit of the electrode can be prevented.

Further, the cover plate 241 can be easily positioned, and positional accuracy of members can be improved by forming the accommodation groove 213.

The present disclosure is not limited to the embodiments described above, and constituent elements can be modified and embodied in an implementation stage without departing from the gist of the disclosure.

For example, although an example of the cover member 24 is described in the embodiments described above in which a plurality of the throttle holes 242 are formed in the cover plate 241, embodiments of this disclosure are not limited thereto. For example, it is sufficient that the cover member 24 is formed with the throttle portion 240 having higher fluid resistance than the pressure chamber 31. For example, the throttle holes may be formed by a plurality of holes in another embodiment.

Further, the number of nozzle rows is not limited to that in the embodiments described above, and one row or three or more rows may be provided.

The actuator 22 may be a single piezoelectric member instead of two piezoelectric members. The dummy chamber 32 may communicate with the first common chamber 271 and the second common chamber 272 which are common chambers. Further, a supply side and a discharge side may be reversed, or may be configured to be switchable.

Although an example of a circulate type ink jet head is described in the embodiments described above in which one side of the pressure chamber 31 is the supply side, the other side is the discharge side, and a fluid flows in from the one side of the pressure chamber and flows out from the other side, embodiments of this disclosure are not limited thereto. For example, the common chambers on both sides of the pressure chamber 31 may be the supply side and the liquid may flow in from both sides. That is, the fluid may flow in from both sides of the pressure chamber 31 and flow out from the nozzle 28 disposed at the center of the pressure chamber 31. In this case, fluid resistance can also be increased and ejection efficiency can also be improved by providing the throttle portion 240 at inlet portions on both sides of the pressure chamber 31.

For example, the liquid to be ejected is not limited to ink for printing, and for example, the embodiments described herein may be applied to an apparatus that ejects a liquid containing conductive particles for forming pattern wiring of a printed wiring board.

For example, although an example is described in the second embodiment in which the entire surface of the end surface 244 is disposed in the accommodation groove 213, embodiments of this disclosure are not limited thereto. For example, a part of the end surface 244 may be disposed on the substrate 21. In this case, since the gap is smaller than that in a case where no accommodation groove 213 is provided, an insulating film for protecting an electrode can also be formed depending on a size.

Although the ink jet head is used in a liquid ejection apparatus such as an ink jet printer in the embodiments described above, embodiments of this disclosure are not limited thereto. For example, the ink jet head may be used in a 3D printer, an industrial manufacturing machine, and a medical application, and the ink jet head can be reduced in size, weight, and cost.

According to at least one of the embodiments described above, it is possible to provide a method for manufacturing a liquid ejection head, a liquid ejection head, and a liquid ejection apparatus that facilitate insulation protection of electrode wiring.

While several embodiments of the present disclosure have been described, the embodiments have been presented by way of example and are not intended to limit the scope of the disclosure. These novel embodiments can be implemented in various other forms, and various omissions, substitutions, and modifications can be made without departing from the gist of the disclosure. The embodiments and the modifications thereof are included in the scope and the gist of the disclosure, and are included in the scope of the disclosure disclosed in the claims and equivalents thereof.

What is claimed is:

1. A liquid ejection head comprising:
a plurality of nozzles through which liquid is ejected;
a plurality of pressure chambers that respectively communicate with the nozzles, volumes of the pressure chambers being varied to eject the liquid through the corresponding nozzles;
a substrate including an electrode on a surface of the substrate;
an actuator connected to the electrode and configured to vary the volumes of the pressure chambers independently according to drive waveforms applied through the electrode, the actuator having a first side surface connected to the surface of the substrate;
a first cover member that covers the first side surface of the actuator and includes a plurality of openings each facing a corresponding one of the pressure chambers, the openings having a larger fluid resistance than the pressure chambers;
an insulating material between the surface of the substrate and the first cover member; and
an insulating film that covers the electrode on the substrate.

2. The liquid ejection head according to claim 1, wherein
the first side surface of the actuator is inclined relative to the surface of the substrate.

3. The liquid ejection head according to claim 1, wherein
the first cover member is a plate-shaped member.

4. The liquid ejection head according to claim 1, wherein
the actuator includes individual electrodes each connected to the electrode of the substrate at a location where the insulating material is disposed.

5. The liquid ejection head according to claim 4, further comprising:
a second cover member, wherein
the actuator includes a second side surface connected to the surface of the substrate on an opposite side of the first side surface,
the second cover member covers the second side surface of the actuator and includes a plurality of openings each facing a corresponding one of the pressure chambers, and
the insulating material fills a first gap between the surface of the substrate and a bottom surface of the first cover member extending from the first side surface of the actuator and a second gap between the surface of the substrate and a bottom surface of the second cover member extending from the second side surface of the actuator.

6. The liquid ejection head according to claim 5, wherein both the first and second side surfaces of the actuator are inclined relative to the surface of the substrate.

7. The liquid ejection head according to claim 1, wherein
the insulating material and the insulating film are made of a same material.

8. The liquid ejection head according to claim 1, further comprising:
a plurality of dummy chambers, each of which is disposed between two of the pressure chambers that are adjacent to each other.

9. The liquid ejection head according to claim 8, wherein
the openings do not face the dummy chambers.

10. The liquid ejection head according to claim 1, wherein
a top surface of the actuator and a top surface of the first cover member are continuous.

11. A method for manufacturing a liquid ejection head, the method comprising:
disposing a cover member on a side surface of an actuator that is disposed on a substrate with an electrode and configured to vary volumes of pressure chambers communicating with nozzles for ejecting liquid according to drive waveforms applied through the electrode, the cover member including openings each facing a corresponding one of the pressure chambers, the openings having larger fluid resistance than the pressure chambers; and
disposing an insulating material between the substrate and the cover member.

12. The method according to claim 11, wherein
disposing the insulating material further includes
supplying the insulating material to a gap between the substrate and the cover member or to the vicinity of the gap until the gap is filled with the insulating material, and
after the gap is filled with the insulating material, supplying the insulating material onto the substrate to form an insulating film.

13. A liquid ejection head comprising:
a plurality of nozzles through which liquid is ejected;
a plurality of pressure chambers that respectively communicate with the nozzles, volumes of the pressure chambers being varied to eject the liquid through the corresponding nozzles;
a substrate;
an actuator configured to vary the volumes of the pressure chambers independently according to drive waveforms respectively applied to the pressure chambers, the actuator having a first side surface connected to the substrate; and
a first cover member that covers the first side surface of the actuator and includes a plurality of openings each facing a corresponding one of the pressure chambers, the openings having larger fluid resistance than the pressure chambers, wherein
the substrate has a first groove extending along the first side surface of the actuator and in which an end portion of the first cover member is disposed.

14. The liquid ejection head according to claim 13, wherein
the first side surface of the actuator is inclined relative to the surface of the substrate.

15. The liquid ejection head according to claim 13 wherein
the first cover member is a plate-shaped member.

16. The liquid ejection head according to claim 13, further comprising:
a second cover member, wherein
the actuator includes a second side surface connected to the substrate on an opposite side of the first side surface,
the second cover member covers the second side surface of the actuator and includes a plurality of openings each facing a corresponding one of the pressure chambers, and
the substrate has a second groove extending along the second side surface of the actuator and in which an end portion of the second cover member is disposed.

17. The liquid ejection head according to claim 16, wherein both the first and second side surfaces of the actuator are inclined relative to the surface of the substrate.

18. The liquid ejection head according to claim 13, further comprising:
a plurality of dummy chambers, each of which is disposed between two of the pressure chambers that are adjacent to each other.

19. The liquid ejection head according to claim 18, wherein
the openings do not face the dummy chambers.

20. The liquid ejection head according to claim 13, wherein
a top surface of the actuator and a top surface of the first cover member are continuous.
